(19) United States
(12) Patent Application Publication
(10) Pub. No.: US 2026/0032197 A1
(43) Pub. Date: Jan. 29, 2026

(54) MULTIPLICITY ELASTICITY

(71) Applicant: Avaya Management L.P., Morristown, NJ (US)

(72) Inventor: Thomas Joseph Moran, Castlerea (IE)

(21) Appl. No.: 18/784,911

(22) Filed: Jul. 25, 2024

(51) Int. Cl. H04M 3/523; G06N 3/08; G06Q 30/01

(52) U.S. Cl. CPC H04M 3/5232; G06N 3/08; G06Q 30/01

(57) ABSTRACT

Systems and methods are disclosed for determining whether a number of concurrent communications comprise content that is exceptionally complex or, conversely, exceptionally non-complex. The concurrent communications may be evaluated by an automated agent, such as an artificial intelligence (AI) that determines complexity indicators for the communications. If the complexity is too high, then the agent handling the concurrent communications may be excluded from adding additional concurrent communications or even have one or more existing concurrent communications transferred away, such as to another agent. If the complexity is exceptionally low, then additional communications may be provided to the agent, thereby improving customer response times and maximizing networking component utilization.

### FIELD OF THE DISCLOSURE

The invention relates generally to systems and methods for management of concurrent communications and particularly to automated resources to determine the complexity of the concurrent communications and manage the number of communications concurrently connected to a particular agent device.

### BACKGROUND

Contact centers commonly utilize agents to interact with customers to resolve work items. The interactions with customers may involve idle periods where the interaction is paused (e.g., on hold) or non-productive to resolving a work item (e.g., chatting about the weather while the customer waits for a download to complete). Certain other forms of communication, such as text messages and email, commonly have a delay from the time the agent sends a message until the agent receives a reply. These delays can be significant.

In order to maximize agent, networking, and computing resources, contact centers often utilize multiplicity wherein an agent is switched, usually automatically, between one or more other interactions. These interactions may be different forms of communications. For example, an agent may concurrently be working three text chats, two email exchanges, and once voice call. Due to the real-time nature of voice calls, agents rarely have more than one concurrent voice interaction.

### SUMMARY

Multiplicity allows for agents and computing and networking resources to be better utilized to handle the same number of interactions. For example, if a single agent only handled a single text chat with a customer, but three other customers were waiting for an interaction with the agent, then the communications system would create an initial record for all the contacts, manage the communications (e.g., keep the customers engaged so they do not abandon the text chat for an even more resource-intensive form of communication, such as a voice call), and then place the customers in a queue for routing to a next available agent. With multiplicity, customer interactions require less time on hold or waiting for an initial agent and the queue of unserviced customers is reduced for the same number of agents. The problem is exacerbated by real-time communications, for example, the resources required to initially answer and hold a call in-queue are even more demanding.

These and other needs are addressed by the various embodiments and configurations of the present invention. The present invention can provide a number of advantages depending on the particular configuration. These and other advantages will be apparent from the disclosure of the invention(s) contained herein.

In some aspects, the techniques described herein relate to a method, including: setting a maximum number of concurrent communications to a default value for an agent device utilized by an agent; upon determining that a number of concurrent communications is less than the maximum number of concurrent communications, connecting a communication to the agent device, wherein the communication includes communication content encoded for transmission over a network between the agent device and a customer device utilized by a customer; monitoring the communication content, by at least one microprocessor executing an automated agent, for each communication of the agent device for complexity indicators; and upon determining that the complexity indicators are above a first threshold complexity value, decreasing the maximum number of concurrent communications.

In some aspects, the techniques described herein relate to a method, further including, upon determining that the complexity indicators are below a second threshold complexity value, increasing the maximum number of concurrent communications.

In some aspects, the techniques described herein relate to a method, wherein monitoring the communication content, by the at least one microprocessor executing the automated agent, includes monitoring the communication content by a neural network trained to determine complexity indicators from the communication content.

In some aspects, the techniques described herein relate to a method, wherein the neural network is trained including: collecting a set of prior communications from a database; applying one or more transformations to each prior communication's content of the set of prior communications including adding or removing a superfluous topic, renaming a subject discussed in the communication, modifying speech providing at least a portion of the communication content, adding or removing a superfluous issue resolution step, adding or removing urgency, improving or impairing communication quality, or adding or removing complexity to create a modified set of prior communications; creating a first training set including the collected set of prior communications, the modified set of prior communications, and a set of known complexity prior communications; training the neural network in a first stage of training using the first training set; creating a second training set for a second stage of training including the first training set and known complexity-indicating content incorrectly determined as erroneously complexity-indicating content after the first stage of training; and training the neural network in the second stage of training using the second training set.

In some aspects, the techniques described herein relate to a method, wherein: monitoring the communication content, by the at least one microprocessor executing the automated agent, includes generating a prompt, the prompt including the communication content, a plurality of prior content with known complexity, and a request to determine the complexity indicators and providing the prompt to the automated agent including an artificial intelligence; and scoring the complexity indicators includes receiving the complexity indicators from the automated agent.

In some aspects, the techniques described herein relate to a method, wherein monitoring the communication content further includes receiving a topic from content prior to connecting the communication to the agent device.

In some aspects, the techniques described herein relate to a method, wherein upon determining that the complexity indicators are above the first threshold complexity value, decreasing the maximum number of concurrent communications, includes transferring at least one communication of the number of concurrent communications to another agent device.

In some aspects, the techniques described herein relate to a method, wherein upon determining that the complexity indicators are above the first threshold complexity value, decreasing the maximum number of concurrent communications further includes, omit connecting the communication to the agent device.

In some aspects, the techniques described herein relate to a method, wherein the maximum number of concurrent communications further includes a maximum number of type-specific communications.

In some aspects, the techniques described herein relate to a method, wherein the type-specific communications include one or more of an audio communication including encoded speech from at least one of the agent or the customer, a video communication including encoded images of at least one of the agent or the customer, an email, or a text chat.

In some aspects, the techniques described herein relate to a system, including: a communication device including a network interface to a network; and at least one microprocessor coupled to a computer memory including instructions, that when read by the at least one microprocessor, cause the at least one microprocessor to perform: setting a maximum number of concurrent communications to a default value for an agent device utilized by an agent; upon determining that a number of concurrent communications is less than the maximum number of concurrent communications, connecting a communication to the agent device, wherein the communication includes communication content encoded for transmission over the network between the agent device and a customer device utilized by a customer; monitoring the communication content, by at least one microprocessor executing an automated agent, for each communication of the agent device for complexity indicators; scoring the complexity indicators; and upon determining that the complexity indicators are above a first threshold complexity value, decreasing the maximum number of concurrent communications.

In some aspects, the techniques described herein relate to a system, wherein the instructions include instructions to cause the at least one microprocessor to perform, upon determining that the complexity indicators are below a second threshold complexity value, increasing the maximum number of concurrent communications.

In some aspects, the techniques described herein relate to a system, wherein the instructions further include instructions to cause the at least one microprocessor to perform executing the automated agent, further including executing a neural network trained to determine complexity indicators from communication content.

In some aspects, the techniques described herein relate to a system, wherein the neural network is trained including: collecting a set of prior communications from a database; applying one or more transformations to each prior communication's content of the set of prior communications including adding or removing a superfluous topic, renaming a subject discussed in the communication, modifying speech providing at least a portion of the communication content, adding or removing a superfluous issue resolution step, adding or removing urgency, improving or impairing communication quality, or adding or removing complexity to create a modified set of prior communications; creating a first training set including the collected set of prior communications, the modified set of prior communications, and a set of known complexity prior communications; training the neural network in a first stage of training using the first training set; creating a second training set for a second stage of training including the first training set and known complexity-indicating content incorrectly determined as erroneously complexity-indicating content after the first stage of training; and training the neural network in the second stage of training using the second training set.

In some aspects, the techniques described herein relate to a system, wherein: monitoring the communication content, by the at least one microprocessor executing the automated agent, includes generating a prompt, the prompt including the communication content, a plurality of prior content with known complexity, and a request to determine the complexity indicators and providing the prompt to the automated agent including an artificial intelligence; and scoring the complexity indicators includes receiving the complexity indicators from the automated agent.

In some aspects, the techniques described herein relate to a system, wherein monitoring the communication content further includes receiving a topic from content prior to connecting the communication to the agent device.

In some aspects, the techniques described herein relate to a system, wherein upon determining that the complexity indicators are above the first threshold complexity value, decreasing the maximum number of concurrent communications, includes transferring at least one communication of the number of concurrent communications to another agent device.

In some aspects, the techniques described herein relate to a system, wherein upon determining that the complexity indicators are above the first threshold complexity value, decreasing the maximum number of concurrent communications further includes, omit connecting the communication to the agent device.

In some aspects, the techniques described herein relate to a system, wherein the agent device includes the at least one microprocessor and the network interface.

In some aspects, the techniques described herein relate to a computer readable memory including instructions to cause at least one microprocessor to perform: setting a maximum number of concurrent communications to a default value for an agent device utilized by an agent; upon determining that a number of concurrent communications is less than the maximum number of concurrent communications, connecting a communication to the agent device, wherein the communication includes communication content encoded for transmission over a network between the agent device and a customer device utilized by a customer; monitoring the communication content, by at least one microprocessor executing an automated agent, for each communication of the agent device for complexity indicators; scoring the complexity indicators; and upon determining that the complexity indicators are above a first threshold complexity value, decreasing the maximum number of concurrent communications.

A system on a chip (SoC) including any one or more of the above aspects or aspects of the embodiments described herein.

One or more means for performing any one or more of the above or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above aspects or aspects of the embodiments described herein, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts a system in accordance with embodiments of the present disclosure;

FIG. 3 depicts a process in accordance with embodiments of the present disclosure;

FIG. 4 depicts a process in accordance with embodiments of the present disclosure; and

FIG. 5 depicts a device of a system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with the like reference number. When such a reference is made in the singular form, but without identification of the sub-reference identifier, it is a reference to one of the like numbered elements, but without limitation as to the particular one of the elements being referenced. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

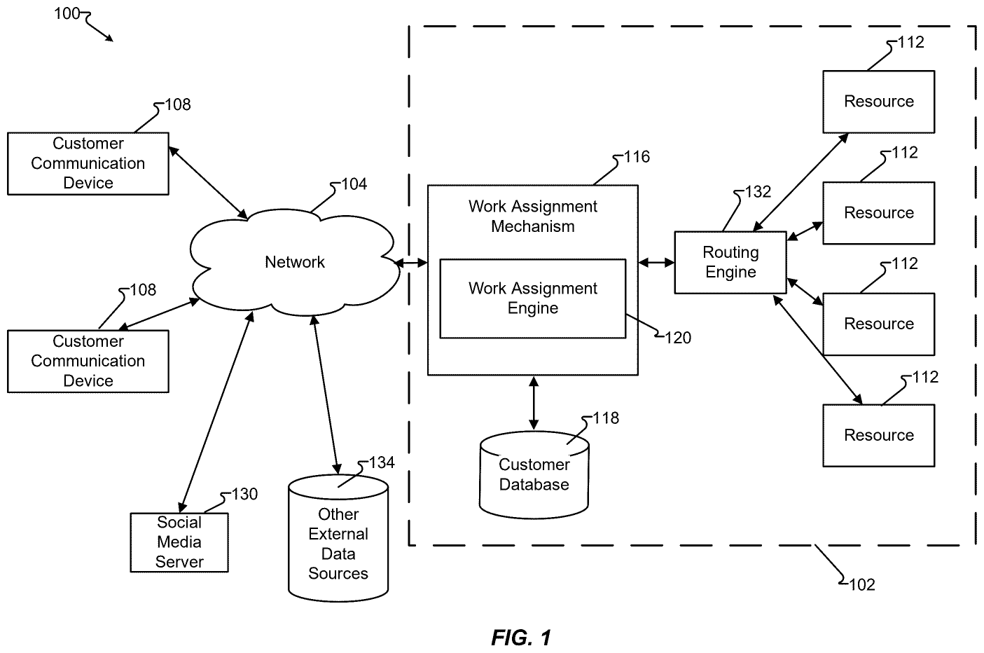

FIG. 1 depicts communication system 100 in accordance with at least some embodiments of the present disclosure. The communication system 100 may be a distributed system and, in some embodiments, comprises a communication network 104 connecting one or more customer communication devices 108 to a work assignment mechanism 116, which may be owned and operated by an enterprise administering contact center 102 in which a plurality of resources 112 is distributed to handle incoming work items (in the form of contacts) from customer communication devices 108.

Contact center 102 is variously embodied to receive and/or send messages that are themselves, or are associated with, work items and the processing and management (e.g., scheduling, assigning, routing, generating, accounting, receiving, monitoring, reviewing, etc.) of the work items by one or more resources 112. The work items are generally generated and/or received requests for a processing resource 112 embodied as, or a component of, an electronic and/or electromagnetically conveyed message. Contact center 102 may include more or fewer components than illustrated and/or provide more or fewer services than illustrated. The border indicating contact center 102 may be a physical boundary (e.g., a building, campus, etc.), legal boundary (e.g., a company, an enterprise, etc.), and/or logical boundary (e.g., resources 112 utilized to provide services to customers of contact center 102).

Furthermore, the border illustrating contact center 102 may be as-illustrated or, in other embodiments, include alterations and/or more and/or fewer components than illustrated. For example, in other embodiments, one or more of resources 112, customer database 118, and/or other components may connect to routing engine 132 via communication network 104, such as when such components connect via a public network (e.g., Internet). In another embodiment, communication network 104 may be a private utilization of, at least in part, a public network (e.g., VPN); a private network located, at least partially, within contact center 102; or a mixture of private and public networks that may be utilized to provide electronic communication of components described herein. Additionally, it should be appreciated that components illustrated as external, such as social media server 130 and/or other external data sources 134, may be within contact center 102 physically and/or logically, but still be considered external for other purposes (e.g., system administration). For example, contact center 102 may operate social media server 130 (e.g., a website operable to receive user messages from customers and/or resources 112) as one means to interact with customers via their customer communication device 108.

Customer communication devices 108 are embodied as external to contact center 102 as they are under the more direct control of their respective user or customer. However, embodiments may be provided whereby one or more customer communication devices 108 are physically and/or logically located within contact center 102 and are still considered external to contact center 102, such as when a customer utilizes customer communication device 108 at a kiosk and attaches to a private network of contact center 102 (e.g., WiFi connection to a kiosk, etc.), within or controlled by contact center 102.

It should be appreciated that the description of contact center 102 provides at least one embodiment whereby the following embodiments may be more readily understood without limiting such embodiments. Contact center 102 may be further altered, added to, and/or subtracted from without departing from the scope of any embodiment described herein and without limiting the scope of the embodiments or claims, except as expressly provided.

Additionally, contact center 102 may incorporate and/or utilize social media server 130 and/or other external data sources 134 may be utilized to provide one means for a resource 112 to receive and/or retrieve contacts and connect to a customer of a contact center 102. Other external data sources 134 may include data sources, such as service bureaus, third-party data providers (e.g., credit agencies, public and/or private records, etc.). Customers may utilize their respective customer communication device 108 to send/receive communications utilizing social media server 130.

In accordance with at least some embodiments of the present disclosure, the communication network 104 may comprise any type of known communication medium or collection of communication media and may use any type of protocols to transport electronic messages between endpoints. The communication network 104 may include wired and/or wireless communication technologies. The Internet is an example of the communication network 104 that constitutes an Internet Protocol (IP) network consisting of many computers, computing networks, and other communication devices located all over the world, which are connected through various telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over IP (VoIP) network, a cellular network, and any other type of packet-switched or circuit-switched network known in the art. In addition, it can be appreciated that the communication network 104 need not be limited to any one network type and instead may be comprised of a number of different networks and/or network types. As one example, embodiments of the present disclosure may be utilized to increase the efficiency of a grid-based contact center 102. Examples of a grid-based contact center 102 are more fully described in U.S. Patent Publication No. 2010/0296417 to Steiner, the entire contents of which are hereby incorporated herein by reference. Moreover, the communication network 104 may comprise a number of different communication media, such as a coaxial cable, copper cable/wire, fiber-optic cable, antennas for transmitting/receiving wireless messages, and combinations thereof.

The customer communication devices 108 may correspond to a particular customer(s). In accordance with at least some embodiments of the present disclosure, a customer may utilize their customer communication device 108 to initiate a work item. Illustrative work items include, but are not limited to, a contact directed toward and received at a contact center 102, a web page request directed toward and received at a server farm (e.g., collection of servers), a media request, an application request (e.g., a request for application resource location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax, and combinations thereof. In some embodiments, the communication may not necessarily be directed at the work assignment mechanism 116, but rather may be on some other server in the communication network 104 where it is harvested by the work assignment mechanism 116, which generates a work item for the harvested communication, such as social media server 130. An example of such a harvested communication includes a social media communication that is harvested by the work assignment mechanism 116 from a social media server 130 or network of servers. Exemplary architectures for harvesting social media communications and generating work items based thereon are described in U.S. patent application Ser. Nos. 12/784,369, 12/706,942, and 12/707,277, filed May 20, 2010, Feb. 17, 2010, and Feb. 17, 2010, respectively; each of which is hereby incorporated herein by reference in its entirety.

The format of the work item may depend upon the capabilities of the customer communication device 108 and/or the format of the communication. In particular, work items are logical representations of work to be performed in connection with servicing a communication received at contact center 102 (and, more specifically, the work assignment mechanism 116). The communication may be received and maintained at the work assignment mechanism 116, a switch or server connected to the work assignment mechanism 116, or the like, until a resource 112 is assigned to the work item representing that communication. At which point, the work assignment mechanism 116 passes the work item to a routing engine 132 to connect the customer communication device 108, which initiated the communication, with the assigned resource 112.

Although the routing engine 132 is depicted as being separate from the work assignment mechanism 116, the routing engine 132 may be incorporated into the work assignment mechanism 116 or its functionality may be executed by the work assignment engine 120.

In accordance with at least some embodiments of the present disclosure, the customer communication devices 108 may comprise any type of known communication equipment or collection of communication equipment. Examples of a suitable customer communication device 108 include, but are not limited to, a personal computer, laptop, Personal Digital Assistant (PDA), cellular phone, smart phone, telephone, or combinations thereof. In general, each customer communication device 108 may be adapted to support video, audio, text, and/or data communications with other customer communication devices 108 as well as the processing resources 112. The type of medium used by the customer communication device 108 to communicate with other customer communication devices 108 or processing resources 112 may depend upon the communication applications available on the customer communication device 108.

In accordance with at least some embodiments of the present disclosure, the work item is sent to a collection of processing resources 112 via the combined efforts of the work assignment mechanism 116 and routing engine 132. The resources 112 can either be completely automated resources (e.g., Interactive Voice Response (IVR) units, microprocessors, servers, or the like), human resources utilizing communication devices (e.g., human agents utilizing a computer, telephone, laptop, etc.), or any other resource known to be used in contact center 102.

As discussed above, the work assignment mechanism 116 and resources 112 may be owned and operated by a common entity in a contact center 102 format. In some embodiments, the work assignment mechanism 116 may be administered by multiple enterprises, each of which has its own dedicated resources 112 connected to the work assignment mechanism 116.

In some embodiments, the work assignment mechanism 116 comprises a work assignment engine 120, which enables the work assignment mechanism 116 to make intelligent routing decisions for work items. In some embodiments, the work assignment engine 120 is configured to administer and make work assignment decisions in a queueless contact center 102, as is described in U.S. Pat. No. 8,634,543 issued on Jan. 21, 2014, the entire contents of which are hereby incorporated herein by reference. In other embodiments, the work assignment engine 120 may be configured to execute work assignment decisions in a traditional queue-based (or skill-based) contact center 102.

The work assignment engine 120 and its various components may reside in the work assignment mechanism 116 or in a number of different servers or processing devices. In some embodiments, cloud-based computing architectures can be employed whereby one or more hardware components of the work assignment mechanism 116 are made available in a cloud or network such that they can be shared resources among a plurality of different users. Work assignment mechanism 116 may access customer database 118, such as to retrieve records, profiles, purchase history, previous work items, and/or other aspects of a customer known to contact center 102. Customer database 118 may be updated in response to a work item and/or input from resource 112 processing the work item.

It should be appreciated that one or more components of contact center 102 may be implemented in a cloud-based architecture in their entirety, or components thereof (e.g., hybrid), in addition to embodiments being entirely on-premises. In one embodiment, customer communication device 108 is connected to one of resources 112 via components entirely hosted by a cloud-based service provider, wherein processing and data storage hardware components may be dedicated to the operator of contact center 102 or shared or distributed among a plurality of service provider customers, one being contact center 102.

In one embodiment, a message is generated by customer communication device 108 and received via communication network 104 at work assignment mechanism 116. The message received by a contact center 102, such as at the work assignment mechanism 116, is generally, and herein, referred to as a “contact.” Routing engine 132 routes the contact to at least one of resources 112 for processing.

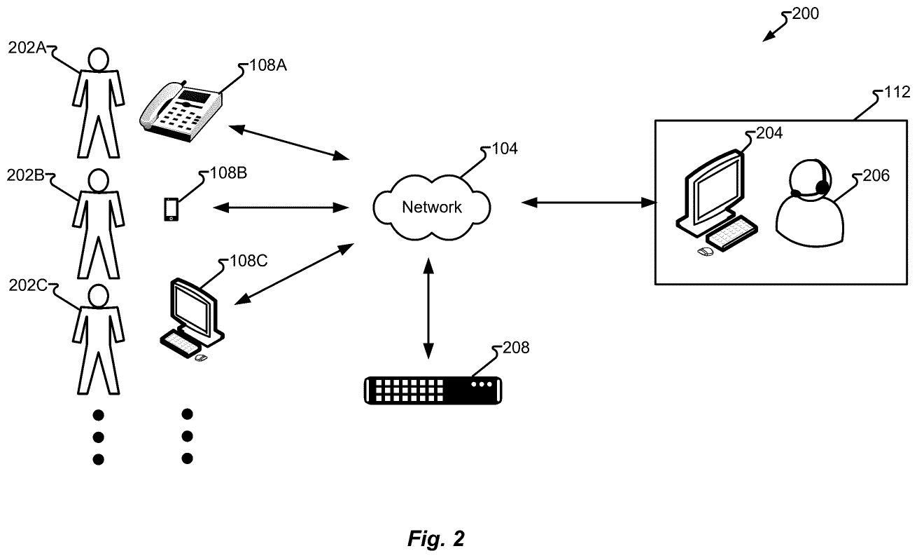

FIG. 2 depicts system 200 in accordance with embodiments of the present disclosure. In one embodiment, system 200 comprises system 100, certain elements of which are omitted to avoid unnecessarily complicating the figure and associated description. In another embodiment, system 200 illustrates one topology of communication devices (e.g., nodes) on network 104. It will be appreciated by those of ordinary skill in the art that other topologies may be utilized without departing from the scope of the disclosure.

System 200 comprises a number of users 202 utilizing a corresponding customer communication device 108, which may be referred to herein as a “customer device,” such as user 202A utilizing voice telephone customer communication device 108A, user 202B utilizing cellular telephone customer communication device 108B, user 202C utilizing personal computer customer communication device 108C, etc. It should be appreciated that certain devices (e.g., cellular telephone customer communication or personal computer customer communication device 108C) may communicate in one or more modes of communication (e.g., voice, video, simple messaging system (SMS) text, email, social media chat, etc.), whereas voice telephone customer communication device 108A may be limited to audio only communications (e.g., speech).

Communications are received by contact center 102, such as by work assignment mechanism 116, and routed by routing engine 132 to a particular resource 112, such as agent 206 utilizing an agent communication device, such as agent device 204. Routing engine 132 and/or other components may determine a multiplicity for agent 206. Multiplicity may allow a plurality of concurrent communications between agent device 204 and a plurality of users 202 via their respective customer communication devices 108. One factor in determining multiplicity is the type of communication. For example, it is difficult to conduct more than one real-time communication (e.g., voice via an audio-only or audio-video communication), therefore multiplicity for audio (or audio-video) may be limited to one. Text messages are near-real-time, in that customers 202 will generally tolerate short delays (e.g., 5-15 seconds) routinely and more (e.g., 3-5 minutes), such as if agent 206 announces to the customer (e.g., user 202B) that they need to confer with their supervisor or do some research. Therefore, the multiplicity factor for text chats may be in the range of 3 to 9. Non-real-time communications, such as email, can be worked simultaneously by agent 206, such as during any idle times or dedicated blocks utilized solely for emails. Multiplicity factor for emails will generally be more than that for text chats, such as the number of emails agent 206 can respond to in a work shift. In another embodiment, multiplicity is provided across communication types. For example, if circumstances require agent 206 to handle two voice calls with customers 202, then contact center 102 may set the number of near-real-time communications to zero in order to not distract the agent from the demands of handling two real-time communications concurrently. Similarly, the number of near-real-time communications may be increased in exchange for pausing all real-time communications and/or reducing email communications.

In another embodiment, server 208 monitors the communications between customers 202 and resources 112. Server 208 may throttle all or certain types of communications concurrently presented to agent device 204. If agent device 204 is handling more communications than desired, then the communications may be routed to a different resource 112 or held in a queue. If server 208 determines the number of communications is below a threshold value, then server 208, when another communication is available, causes agent device 204 to be connected to the communication for concurrent communication.

In another embodiment, the threshold of communications is determined, in whole or in part, by the complexity of the communications currently underway and/or pending in a queue waiting to be connected to agent device 204. Server 208 monitors the communication content conveyed within each concurrent and/or pending communication to identify complexity indicators. The complexity indicators alone or via subsequent scoring then determine a number of overall concurrent communications and/or number of type-specific communications (e.g., voice calls, text chats, etc.).

In embodiment, server 208 comprises an artificial intelligent (AI) agent that determines the complexity, or complexity indicators, of the communications. Complexity indicators are variously embodied and may include one or more of communication issues with user 202 (e.g., a noisy background during a voice call, speech accent or impediment, or poor signal fidelity such as may be caused by weak cellular service), customer familiarity with the subject matter discussed during the communication, features of the subject matter being easily misinterpreted, the customer omitting key facts and/or including irrelevant facts, transient issues that cannot be reliably reproduced and diagnosed, unexpected results from an existing resolution step, two or more concurrent problems, a need for precision in timing, a need for precision in motion or dexterity, resolution steps that are easily confusable with irrelevant or detrimental steps, easily overlooked or missed steps, a large number of steps to resolve an issue, urgent need to resolve an issue, and combinations thereof. The foregoing is not an exhaustive list as the AI agent will be trained or learn what communication content is more, or less, complex and determine the complexity interactors accordingly. For example, if a work item discussed in a call is resolved quickly, then the subject matter and/or other factors within the communication content would be determined to indicate a lower complexity. Conversely, if a work item failed to get resolved, required excessive time, repeated portions, had stress indicators in the voice of the agent and/or customer, required a call-back due to an unresolved issue, etc., then the AI agent would determine such communication content indicates a higher complexity. As a result, the AI agent may be trained initially or continually based on learned and/or corrected decision making as to what, and to what degree, the communication content indicated a particular complexity.

When server 208 determines that the complexity indicators are above a previously determined threshold or a dynamically determined threshold, a maximum number of concurrent communications is decreased, such as by one or more of all communications or a particular type of communication is decreased (e.g., discontinue all voice calls, reduce text chats by two, etc.). As a further option, agent 206 may have an exceptionally complex communication and, as a result, server 208 transfers an ongoing communication to another agent or puts the communication on hold. The communication transferred may be the exceptionally complex communication itself or one or more other communications. A dynamically determined threshold may be variously determined, such as via monitoring biometrics (e.g., voice stress indicators, facial expressions, body position, etc.) to determine if agent 206 is stressed and, therefore more likely to have a lower tolerance for complexity. The biometric sensors may be explicit biometric monitoring devices (e.g., a heart rate monitor, respiratory monitor, etc.) or extracted from other inputs, such as voice stress from an audio input, a facial expression or gesture from a video input, or still images from a video input. Monitoring the communication content by server 208 to determine if customers 202 are feeling ignored or neglected (e.g., “Are you still there?”, “Why is this taking so long?”, etc.) or determine if agent 206 is unable to maintain the thread of communication content (e.g., “Sorry, tell me again what you said,” “Now I need you to perform step three,” when user 202 previously indicated they have performed step three, etc.). Conversely, if agent 206 indicates a relaxed physical state, then a relaxed mental state may be assumed, and the complexity tolerance for agent 206 may be higher.

The reduced number of communications may be limited to the duration of time wherein the complexity indicators are above the threshold amount or extended for a period of time, such as to allow agent 206 to recover. In another embodiment, if the complexity indicators are below another threshold, then additional communications may be added to the pool of concurrent communications of agent device 204.

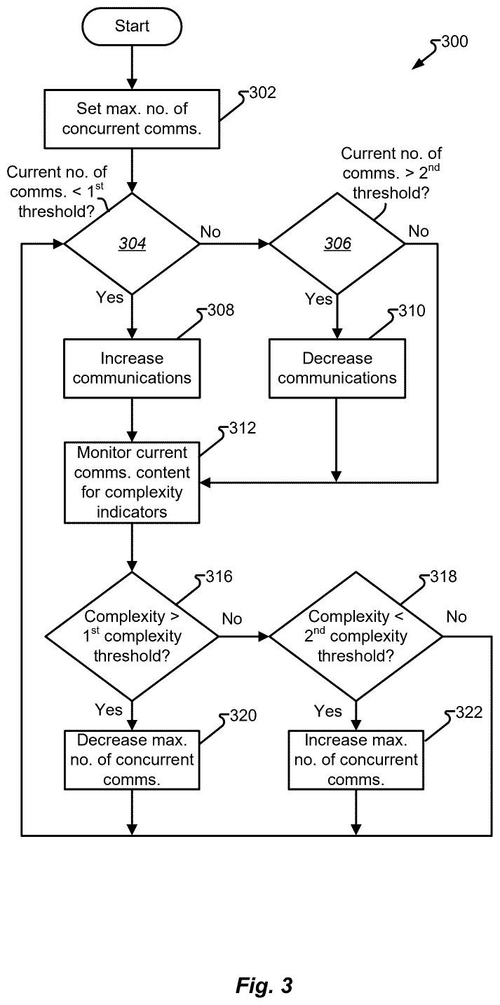

FIG. 3 depicts process 300 in accordance with embodiments of the present disclosure. In one embodiment, process 300 is embodied as machine-readable instructions maintained in a non-transitory memory that when read by a machine, such as a processor of a server, cause the machine to execute the instructions and thereby execute process 300. The processor of the server may include, but is not limited to, at least one processor of server 208.

Process 300 begins and, in step 302, a maximum number of concurrent communications is set. The maximum number of concurrent communications may be a total or overall number of concurrent communications or a number for each specific type (e.g., voice, text chat, etc.) of communication. Step 302 may set the maximum number of concurrent communications based on a default value for all agents or a value based on historic norms for contact center 102 and/or agent 206.

Test 304 determines if the current number of communications (and/or any one or more specific type of communication) is less than a first threshold, the first threshold being previously or dynamically determined. If test 304 is determined in the affirmative, processing continues to step 308 and the number of communications (or specific type of communication(s)) is increased. The increase may comprise signaling routing engine 132 and/or other components of contact center 102 to provide agent 206 with another communication if/when one is available.

Step 312 then monitors the current communication content for complexity indicators. Test 316 determines if the complexity indicators are greater than a first complexity threshold and, if determined in the affirmative, the maximum number of concurrent communications is decreased in step 320. Processing then loops back to test 304.

When test 304 is determined in the negative, processing continues to test 306. Notably, processing omits step 308, resulting in no additional communications being added. Test 306 determines if the number of concurrent communications is greater than a second threshold. Test 306 may be a “high water” test to determine if agent 206 is unable to accept additional communications but may further determine if the current complexity indicators require a current communication to be removed from agent 206, such as to place one or more current communications on hold or transfer the one or more current communications to a different agent in step 310. Accordingly, step 310 may cause additional communications to be refused and/or one or more current communications to be transferred to another agent. After step 310, or when test 306 is determined in the negative, processing continues to step 312 for monitoring current communication content and determining if the complexity indicators are greater than the first complexity threshold in test 316.

If test 316 is determined in the negative, test 318 then determines if the complexity indicators are less than a second complexity threshold, the second complexity threshold being a threshold determined to indicate that agent 206 can successfully handle an increase in the number of concurrent communications. Accordingly, when test 318 is determined in the affirmative, test 322 increases the maximum number of concurrent communications. After step 318, or when test 318 is determined in the negative, processing loops back to test 304. Process 300 may continue without end, or terminate at any time, such as at a break period or the end of a work shift for agent 206, which may allow agent 206 to conclude all existing concurrent communications, or at least all existing real-time and near real-time communications, without adding any new communications until agent 206 returns from break or starts a new work shift.

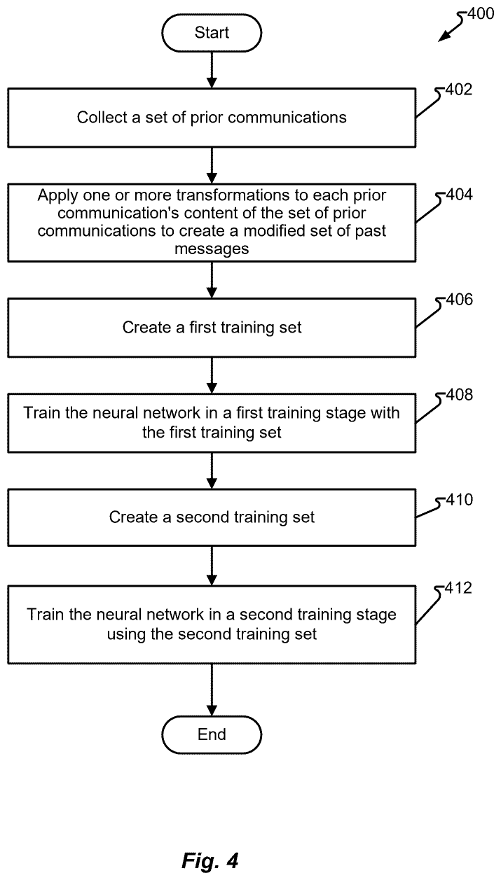

FIG. 4 depicts process 400 in accordance with embodiments of the present disclosure. In one embodiment, process 400 is embodied as machine-readable instructions maintained in a non-transitory memory that when read by a machine, such as a processor of a server, cause the machine to execute the instructions and thereby execute process 400. The processor of the server may include, but is not limited to, at least one processor of server 208.

In one embodiment, process 400 begins and, in step 402, a set of prior communications are collected from a database. The set of prior communications may comprise communication content for one or more types of communications (e.g., voice, text, email, audio-video, etc.). Each communication of the set of prior communications comprises communication content. The communication content includes express content (e.g., words and phrases spoken or typed) and/or implied content. The implied content may comprise expressed emotions (e.g., laughing, crying, yelling, cursing, etc.), voice stress indicators (e.g., cracking, pleasant, etc.), etc.

Step 404 then applies one or more transformations to each prior communication's content of the set of prior communications, including adding or removing a superfluous topic, renaming a subject discussed in the communication, modifying speech providing at least a portion of the communication's content, adding or removing a superfluous issue resolution step, adding or removing urgency, improving or impairing communication quality, or adding or removing complexity to create a modified set of prior communications.

Step 406 creates a first training set comprising the collected set of prior communications, the modified set of prior communications, and a set of known complexity prior communications. Step 408 then trains the neural network in a first stage of training using the first training set and step 410 creates a second training set for a second stage of training comprising the first training set's known complexity-indicating content incorrectly determined as erroneously to be complexity-indicating content.

A neural network, as is known in the art and in one embodiment, self-configures layers of logical nodes having an input and an output. If an output is below a self-determined threshold level, the output is omitted (i.e., the inputs are within the inactive response portion of a scale and provide no output). If the self-determined threshold level is above the threshold, an output is provided (i.e., the inputs are within the active response portion of a scale and provide an output). The particular placement of the active and inactive delineation is provided as a training step or steps. Multiple inputs into a node produce a multi-dimensional plane (e.g., hyperplane) to delineate a combination of inputs that are active or inactive.

Step 412 then trains the neural network in the second stage of training using the second training set. After training, an artificial agent, which may comprise or utilize the neural network, may be provided with an ongoing communication(s) between an agent, such as agent 206, and user(s) 202. The neural network may be executed on server 208 and/or other server(s), such as “cloud” computing service. The neural network then returns complexity indicator(s), such as a score (e.g., “low-med-high,” one-to-ten, etc.) for the ongoing communication(s). When the complexity indicator(s) are greater than one threshold, the agent may have ongoing communications removed, such as transferred to another agent. When the complexity indicator(s) are lower than a second threshold, then the agent may be provided with one or more additional concurrent communication. Additionally or alternatively, a communication may be received by contact center 102 but not yet connected to any agent, such as when user 202 initially interacts with an IVR or other automated system. Such initial interactions may indicate an emotional state (e.g., the user's voice is stressed, the user explicitly stated they were angry, etc.) and the emotional state then provides, or indicates, a complexity indicator. Additionally, the subject matter (e.g., “I forgot my password,” or “Does clause 13 apply in view of the new law?”) may be provided to a voicemail or automated system wherein the complexity may be determined therefrom. As a further option, voicemail may capture other indicators of complexity, such as a pattern of speech of the customer (e.g., accent, relaxed, urgent, etc.), connection quality (e.g., significant background noise, poor cellular connectivity, etc.), means of expression (e.g., verbose), or customer attribute (e.g., apparent age), any one or more of which may further contribute to determining the complexity indicator(s).

In another embodiment, the artificial agent is untrained and instead provided with a prompt. The prompt may be generated to include one or more ongoing concurrent communications or indicia or portions thereof, such as a text generated from speech from a communication. The prompt may comprise prior communications having known complexity indicators, and the prompt may further comprise a request to determine a degree of association between one or more ongoing concurrent communications and, therefrom, return a complexity indicator.

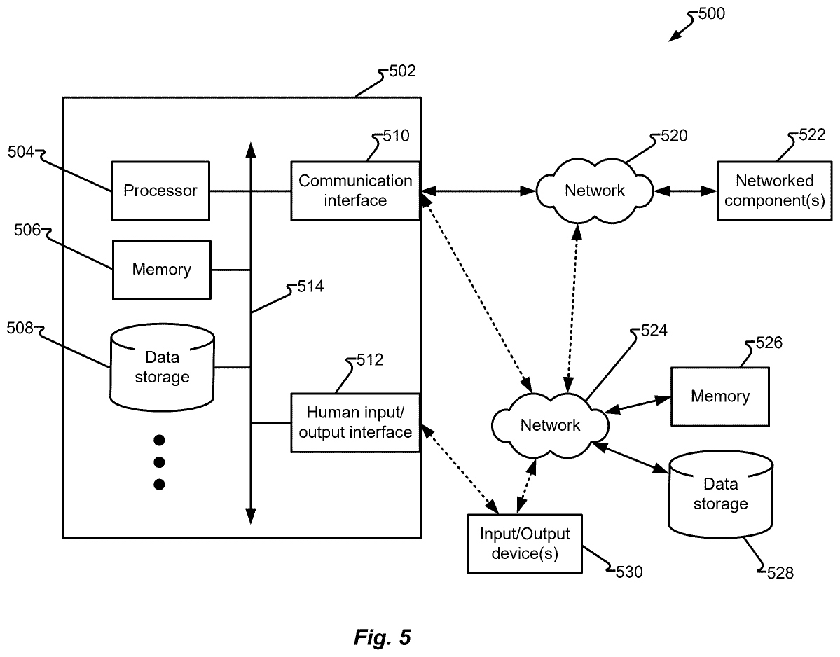

FIG. 5 depicts device 502 in system 500 in accordance with embodiments of the present disclosure. In one embodiment, server 208 and/or agent device 204 may be embodied, in whole or in part, as device 502 comprising various components and connections to other components and/or systems. The components are variously embodied and may comprise processor 504. The term “processor,” as used herein, refers exclusively to electronic hardware components comprising electrical circuitry with connections (e.g., pin-outs) to convey encoded electrical signals to and from the electrical circuitry. Processor 504 may comprise programmable logic functionality, such as determined, at least in part, from accessing machine-readable instructions maintained in a non-transitory data storage, which may be embodied as circuitry, on-chip read-only memory, computer memory 506, data storage 508, etc., that cause the processor 504 to perform the steps of the instructions. Processor 504 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 514, executes instructions, and outputs data, again such as via bus 514. In other embodiments, processor 504 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 504 is a non-transitory computing device (e.g., electronic machine comprising circuitry and connections to communicate with other components and devices). Processor 504 may operate a virtual processor, such as to process machine instructions not native to the processor (e.g., translate the VAX operating system and VAX machine instruction code set into Intel® 9xx chipset code to enable VAX-specific applications to execute on a virtual VAX processor). However, as those of ordinary skill understand, such virtual processors are applications executed by hardware, more specifically, the underlying electrical circuitry and other hardware of the processor (e.g., processor 504). Processor 504 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 504, device 502 may utilize computer memory 506 and/or data storage 508 for the storage of accessible data, such as instructions, values, etc. Communication interface 510 facilitates communication with components, such as processor 504 via bus 514 with components not accessible via bus 514 and may be embodied as a network interface (e.g., ethernet card, wireless networking components, USB port, etc.). Communication interface 510 may be embodied as a network port, card, cable, or other configured hardware device. Additionally or alternatively, human input/output interface 512 connects to one or more interface components to receive and/or present information (e.g., instructions, data, values, etc.) to and/or from a human and/or electronic device. Examples of input/output devices 530 that may be connected to input/output interface include, but are not limited to, keyboard, mouse, trackball, printers, displays, sensor, switch, relay, speaker, microphone, still and/or video camera (including images, or frames, of a video image), etc. In another embodiment, communication interface 510 may comprise, or be comprised by, human input/output interface 512. Communication interface 510 may be configured to communicate directly with a networked component or configured to utilize one or more networks, such as network 520 and/or network 524.

Network 104 may be embodied, in whole or in part, as network 520. Network 520 may be a wired network (e.g., Ethernet), wireless (e.g., WiFi, Bluetooth, cellular, etc.) network, or combination thereof and enable device 502 to communicate with networked component(s) 522. In other embodiments, network 520 may be embodied, in whole or in part, as a telephony network (e.g., public switched telephone network (PSTN), private branch exchange (PBX), cellular telephony network, etc.).

Additionally or alternatively, one or more other networks may be utilized. For example, network 524 may represent a second network, which may facilitate communication with components utilized by device 502. For example, network 524 may be an internal network to a business entity or other organization, such as contact center 102, whereby components are trusted (or at least more so) than networked components 522, which may be connected to network 520 comprising a public network (e.g., Internet) that may not be as trusted.

Components attached to network 524 may include computer memory 526, data storage 528, input/output device(s) 530, and/or other components that may be accessible to processor 504. For example, computer memory 526 and/or data storage 528 may supplement or supplant computer memory 506 and/or data storage 508 entirely or for a particular task or purpose. As another example, computer memory 526 and/or data storage 528 may be an external data repository (e.g., server farm, array, “cloud,” etc.) and enable device 502, and/or other devices, to access data thereon. Similarly, input/output device(s) 530 may be accessed by processor 504 via human input/output interface 512 and/or via communication interface 510 either directly, via network 524, via network 520 alone (not shown), or via networks 524 and 520. Each of computer memory 506, data storage 508, computer memory 526, data storage 528 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 530 may be a router, a switch, a port, or other communication component such that a particular output of processor 504 enables (or disables) input/output device 530, which may be associated with network 520 and/or network 524, to allow (or disallow) communications between two or more nodes on network 520 and/or network 524. For example, a connection between one particular customer, using a particular customer communication device 108, may be enabled (or disabled) with a particular networked component 522 and/or particular resource 112. Similarly, one particular networked component 522 and/or resource 112 may be enabled (or disabled) from communicating with a particular other networked component 522 and/or resource 112, including, in certain embodiments, device 502 or vice versa. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components by, in one or more embodiments, voltages in memory circuits, configuration of switching circuits, and/or by selective use of particular logic gate circuits. Additionally or alternatively, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessors may be integrated into a single processing appliance (e.g., computer, server, blade, etc.) or located entirely, or in part, in a discrete component and connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, a first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon®610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A method, comprising:
setting a maximum number of concurrent communications to a default value for an agent device utilized by an agent;
upon determining that a number of concurrent communications is less than the maximum number of concurrent communications, connecting a communication to the agent device, wherein the communication comprises communication content encoded for transmission over a network between the agent device and a customer device utilized by a customer;
monitoring the communication content, by at least one microprocessor executing an automated agent, for each communication of the agent device for complexity indicators; and
upon determining that the complexity indicators are above a first threshold complexity value, decreasing the maximum number of concurrent communications.

2. The method of claim 1, further comprising, upon determining that the complexity indicators are below a second threshold complexity value, increasing the maximum number of concurrent communications.

3. The method of claim 1, wherein monitoring the communication content, by the at least one microprocessor executing the automated agent, comprises monitoring the communication content by a neural network trained to determine the complexity indicators from the communication content.

4. The method of claim 3, wherein the neural network is trained comprising:
collecting a set of prior communications from a database;
applying one or more transformations to each prior communication's content of the set of prior communications including adding or removing a superfluous topic, renaming a subject discussed in the communication, modifying speech providing at least a portion of the communication content, adding or removing a superfluous issue resolution step, adding or removing urgency, improving or impairing communication quality, or adding or removing complexity to create a modified set of prior communications;
creating a first training set comprising the collected set of prior communications, the modified set of prior communications, and a set of known complexity prior communications;
training the neural network in a first stage of training using the first training set;
creating a second training set for a second stage of training comprising the first training set and known complexity-indicating content incorrectly determined as erroneously complexity-indicating content after the first stage of training; and
training the neural network in the second stage of training using the second training set.

5. The method of claim 1, wherein:
monitoring the communication content, by the at least one microprocessor executing the automated agent, comprises generating a prompt, the prompt comprising the communication content, a plurality of prior content with known complexity, and a request to determine the complexity indicators and providing the prompt to the automated agent comprising an artificial intelligence; and
scoring the complexity indicators comprises receiving the complexity indicators from the automated agent.

6. The method of claim 1, wherein monitoring the communication content further comprises receiving a topic from content prior to connecting the communication to the agent device.

7. The method of claim 1, wherein upon determining that the complexity indicators are above the first threshold complexity value, further comprises decreasing the maximum number of concurrent communications comprises transferring at least one communication of the number of concurrent communications to another agent device.

8. The method of claim 1, wherein upon determining that the complexity indicators are above the first threshold complexity value, further comprises decreasing the maximum number of concurrent communications further comprises omitting connecting the communication to the agent device.

9. The method of claim 1, wherein the maximum number of concurrent communications further comprises a maximum number of type-specific communications.

10. The method of claim 9, wherein the type-specific communications comprise one or more of an audio communication comprising encoded speech from at least one of the agent or the customer, a video communication comprising encoded images of at least one of the agent or the customer, an email, or a text chat.

11. A system, comprising:
a communication device comprising a network interface to a network; and
at least one microprocessor coupled to a computer memory comprising instructions, that when read by the at least one microprocessor, cause the at least one microprocessor to perform:
setting a maximum number of concurrent communications to a default value for an agent device utilized by an agent;
upon determining that a number of concurrent communications is less than the maximum number of concurrent communications, connecting a communication to the agent device, wherein the communication comprises communication content encoded for transmission over the network between the agent device and a customer device utilized by a customer;
monitoring the communication content, by at least one microprocessor executing an automated agent, for each communication of the agent device for complexity indicators;
scoring the complexity indicators; and
upon determining that the complexity indicators are above a first threshold complexity value, decreasing the maximum number of concurrent communications.

12. The system of claim 11, wherein the instructions further comprise instructions to cause the at least one microprocessor to perform, upon determining that the complexity indicators are below a second threshold complexity value, increasing the maximum number of concurrent communications.

13. The system of claim 11, wherein the instructions further comprise instructions to cause the at least one microprocessor to perform executing the automated agent, further comprising executing a neural network trained to determine the complexity indicators from communication content.

14. The system of claim 13, wherein the neural network is trained comprising:
collecting a set of prior communications from a database;
applying one or more transformations to each prior communication's content of the set of prior communications including adding or removing a superfluous topic, renaming a subject discussed in the communication, modifying speech providing at least a portion of the communication content, adding or removing a superfluous issue resolution step, adding or removing urgency, improving or impairing communication quality, or adding or removing complexity to create a modified set of prior communications;
creating a first training set comprising the collected set of prior communications, the modified set of prior communications, and a set of known complexity prior communications;
training the neural network in a first stage using the first training set;
creating a second training set for a second stage of training comprising the first training set and known complexity-indicating content incorrectly determined as erroneously complexity-indicating content after the first stage of training; and
training the neural network in the second stage using the second training set.

15. The system of claim 11, wherein:
monitoring the communication content, by the at least one microprocessor executing the automated agent, comprises generating a prompt, the prompt comprising the communication content, a plurality of prior content with known complexity, and a request to determine the complexity indicators and providing the prompt to the automated agent comprising an artificial intelligence; and
scoring the complexity indicators comprises receiving the complexity indicators from the automated agent.

16. The system of claim 11, wherein monitoring the communication content further comprises receiving a topic from content prior to connecting the communication to the agent device.

17. The system of claim 11, wherein upon determining that the complexity indicators are above the first threshold complexity value, further comprising decreasing the maximum number of concurrent communications, comprises transferring at least one communication of the number of concurrent communications to another agent device.

18. The system of claim 11, wherein upon determining that the complexity indicators are above the first threshold complexity value, further comprising decreasing the maximum number of concurrent communications further comprises omitting connecting the communication to the agent device.

19. The system of claim 11, wherein the agent device comprises the at least one microprocessor and the network interface.

20. A computer readable memory comprising instructions to cause at least one microprocessor to perform:
setting a maximum number of concurrent communications to a default value for an agent device utilized by an agent;
upon determining that a number of concurrent communications is less than the maximum number of concurrent communications, connecting a communication to the agent device, wherein the communication comprises communication content encoded for transmission over a network between the agent device and a customer device utilized by a customer;
monitoring the communication content, by at least one microprocessor executing an automated agent, for each communication of the agent device for complexity indicators;
scoring the complexity indicators; and
upon determining that the complexity indicators are above a first threshold complexity value, decreasing the maximum number of concurrent communications.
